(19) United States
(12) Patent Application Publication
(10) Pub. No.: US 2017/0055798 A1
(43) Pub. Date: Mar. 2, 2017

(54) WOOD FLOOR MOP ASSEMBLY

(71) Applicant: Bonakemi USA, Incorporated, Aurora, CO (US)

(72) Inventors: Frank E. Garrett, Barrington, IL (US); Michael Garrett, Northbrook, IL (US); Jackson Wilson, Northbrook, IL (US); Dan Smith, Westminster, CO (US)

(21) Appl. No.: 15/245,930

(22) Filed: Aug. 24, 2016

Related U.S. Application Data
(60) Provisional application No. 62/212,448, filed on Aug. 31, 2015.

(51) Int. Cl. A47L 13/22; B05B 11/00; A47L 13/44

(52) U.S. Cl. CPC A47L 13/22; A47L 13/44; B05B 11/0005

(57) ABSTRACT

A wood floor mop assembly includes a liquid reservoir adapted to hold floor cleaning liquid; a liquid spray nozzle assembly in selective fluid communication with floor cleaning liquid in the liquid reservoir; and a heating unit operatively associated with the liquid reservoir and adapted to heat floor cleaning liquid in the liquid reservoir.

This application claims the benefit of U.S. Provisional Patent Application Ser. No. 62/212,448 filed Aug. 31, 2015 for WOOD FLOOR MOP ASSEMBLY, which is hereby incorporated by reference for all that it discloses.

### BACKGROUND

Floor mops have been used to clean floor surfaces such as hardwood floors, tile floors, granite floors and the like for hundreds of years. A mop includes a mop head, which is moved across a floor to be cleaned, and an elongate mop handle, which is attached to the mop head. Mop heads come in various configurations depending upon the type of mop.

Classic floor mops have mop heads with many rope-like liquid absorbent strands connected together at one end. Such mops are often used in combination with a mop bucket and ringer assembly. With such a mop and bucket system, the mop head is soaked in water or other cleaning liquid contained in the mop bucket. Excess liquid is rung out of the mop head and the damp mop head is then moved across a floor to clean it. The cleaning liquid in the mop bucket is sometimes heated to increase the cleaning effectiveness of the mop.

In modern floor mops, some mop heads include a rigid plate member to which other, softer, dirt trapping cleaning devices are attached. For example, a cleaning cloth might be attached to such a rigid plate as by hook and fastener type strips, tie-on cords, clamps or other attachment means.

In some mops the mop head and mop handle are attached through a universal pivot assembly or knuckle that allows pivotal displacement of the handle relative to the mop head about two different pivot axes. Most mop handles are straight, but curved mop handles, mop handles with pistol grips, etc., are also known in the art. Recently, floor mops have been provided with fluid dispensing systems mounted on the mop handle. A user actuates a fluid dispensing system through a handle-mounted trigger to dispense floor cleaning fluid or the like as the mop is moved across the floor. Some mops use an aerosol type fluid dispenser while others employ a mechanical pump assembly to dispense cleaning fluid.

### SUMMARY

This specification discloses a wood floor mop assembly includes a liquid reservoir adapted to hold floor cleaning liquid. A liquid spray nozzle is in selective fluid communication with floor cleaning liquid in the liquid reservoir. A heating unit is operatively associated with the liquid reservoir and is adapted to heat the liquid in the liquid reservoir to a predetermined temperature.

Also disclosed in this specification is a heating assembly for heating wood floor cleaning liquid. This assembly includes a container support unit for supporting a liquid container therein. A heater is positioned proximate the container support unit for heating liquid in a container supported by the container support unit. A heater thermal sensor senses the temperature of the heater. A liquid thermal sensor senses the temperature of cleaning liquid in the liquid container while it is supported by the container support unit.

Also disclosed in this specification is a method of cleaning a wood floor. The method includes heating floor cleaning liquid in a cleaning liquid reservoir of a wood floor mop.

### BRIEF DESCRIPTION OF THE DRAWINGS

FIG. 1 is an isometric view of a prior art floor mop.

FIG. 2 is a right side elevation view of the floor mop of FIG. 1 in a first cleaning position.

FIG. 3 is a left side elevation view of the floor mop of FIG. 1 in a second cleaning position.

FIG. 4 is an exploded detailed isometric view of the prior art floor mop of FIG. 1.

FIG. 5 is a block diagram of a heating assembly for floor cleaning liquid that is a component of a mop assembly.

FIG. 6 is an isometric view of a portion of a heating assembly for floor cleaning liquid.

FIG. 7 is an isometric view of another heating assembly for floor cleaning liquid.

FIG. 8 is a side elevation view of the heating assembly of FIG. 7 and a container that is mounted on the heating assembly.

FIG. 9 is and isometric view of a floor liquid container bottle.

FIG. 10 is a partially transparent view of the container bottle of FIG. 9 and certain control circuitry enclosed in an insulating shroud.

FIG. 11 is and isometric view of the container bottle of FIG. 9 enclosed in a shroud that also encloses a heating unit and control electronics.

FIG. 12 is a cross sectional view of the assembly of FIG. 11.

FIG. 13 is a frontal exploded view of an example floor mop cleaning liquid heating and spray assembly that includes a liquid container support member that is connectable to a power source.

FIG. 14 is a cross sectional side elevation view of the container support of FIG. 13.

FIG. 15 a cross sectional front elevation view of the container support of FIG. 13.

FIG. 16 a lateral cross sectional view of the container support of FIG. 13.

FIG. 17 another lateral cross sectional view of the container support of FIG. 13.

FIG. 18 is an exploded rear view of the container and the support member shown in FIG. 13.

FIG. 19 is an isometric view of an example floor mop.

FIG. 20 is an isometric view of a typical spray pattern produced by a prior art spray mop.

FIG. 21 is an isometric view of a spray pattern for a heated spray mop.

FIG. 22 is a flow diagram of an example method of cleaning a floor.

FIG. 23 is a flow diagram of another example method of cleaning a floor.

### DETAILED DESCRIPTION

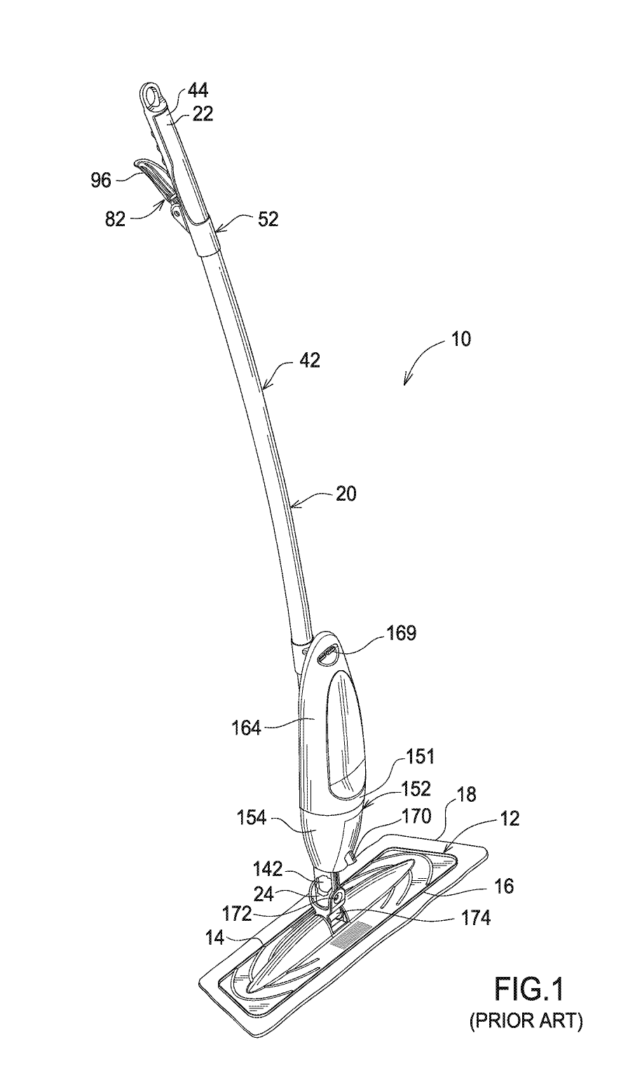

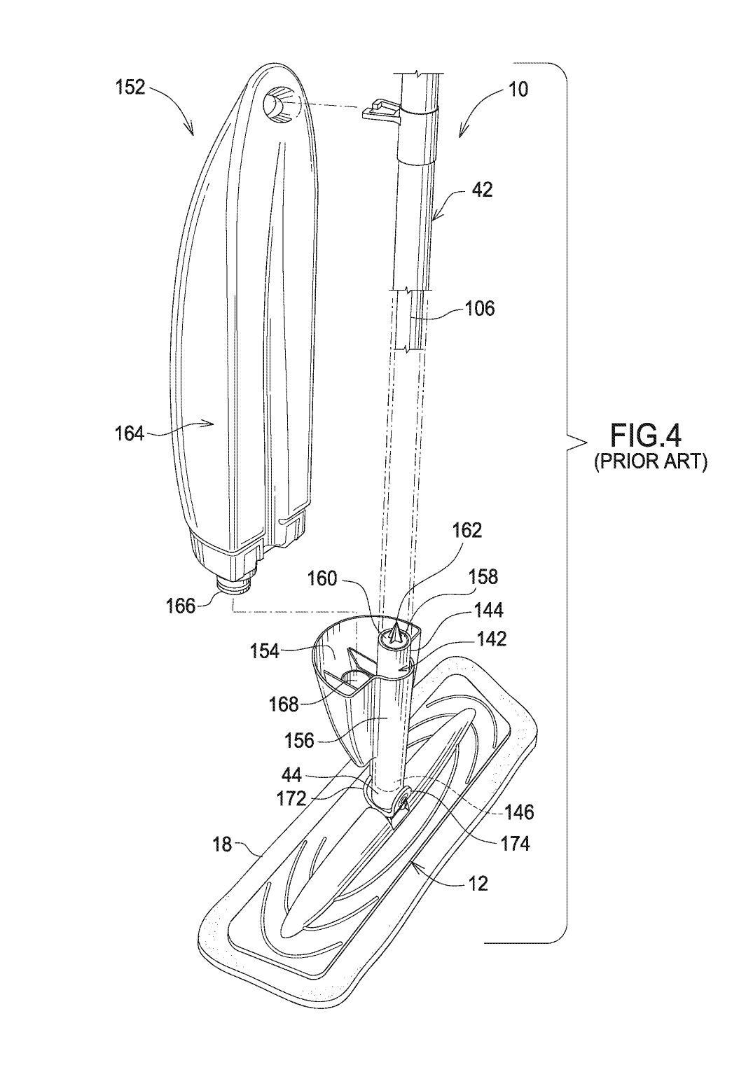

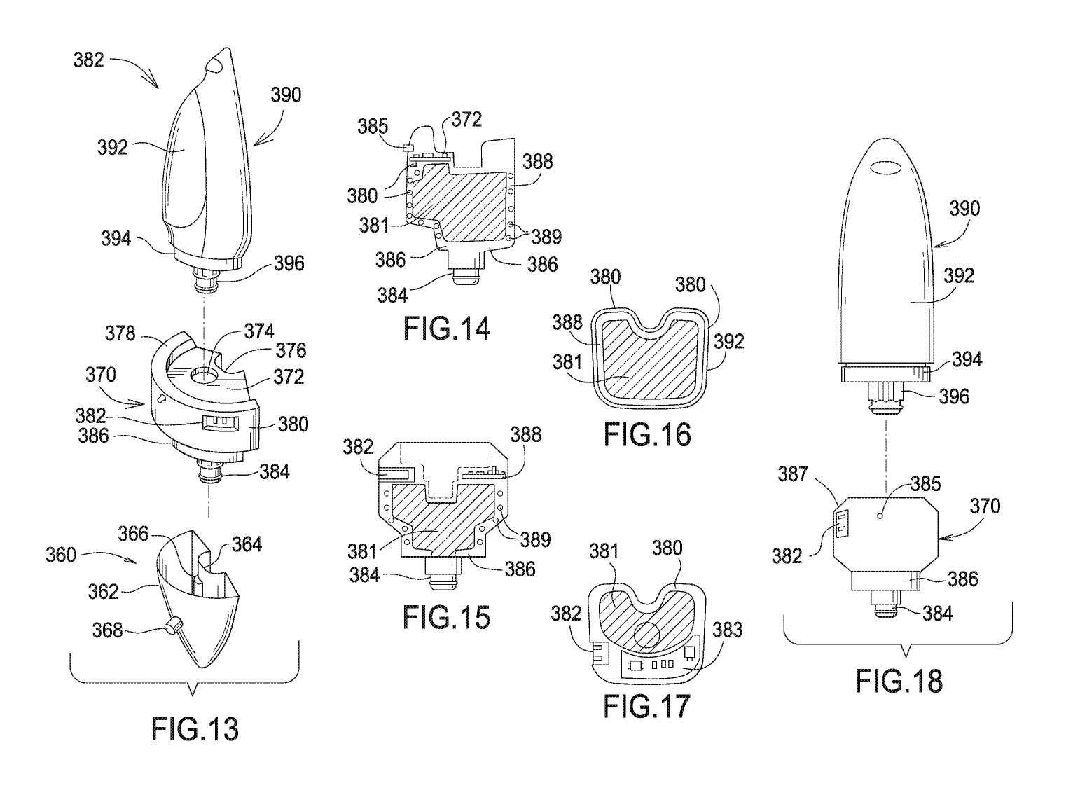

In modern mop systems such as the prior art mop system described below with reference to FIGS. 1-4, the separate mop bucket has been eliminated and floor cleaning liquid is sprayed onto the floor from a reservoir mounted on the mop. However, such modern mop assemblies have been unable to conveniently provide heated cleaning liquid that may be sprayed onto a floor from the mop liquid reservoir as the mop is moved across the floor. The mop assembly described below with reference to FIGS. 5 to 21 is adapted to heat floor treating liquid within a mop reservoir. The heated liquid may then be sprayed on the floor during mopping to increase the cleaning effectiveness of the mop.

FIG. 1 illustrates a prior art floor mop 10 having a conventional mop head 12 with a trailing edge 14 and a leading edge 16. A cleaning pad may be attached to the mop head 12 as by hook and loop type fasteners strips (not shown) mounted on the bottom of the mop head or by adhesives strips, tie-on cords or other cleaning pad attachment means. The floor mop 10 illustrated in FIGS. 1-4 is described in detail in U.S. Patent Publication 2012/00227763, published Sep. 13, 2012, which is hereby incorporated by reference for all that it discloses.

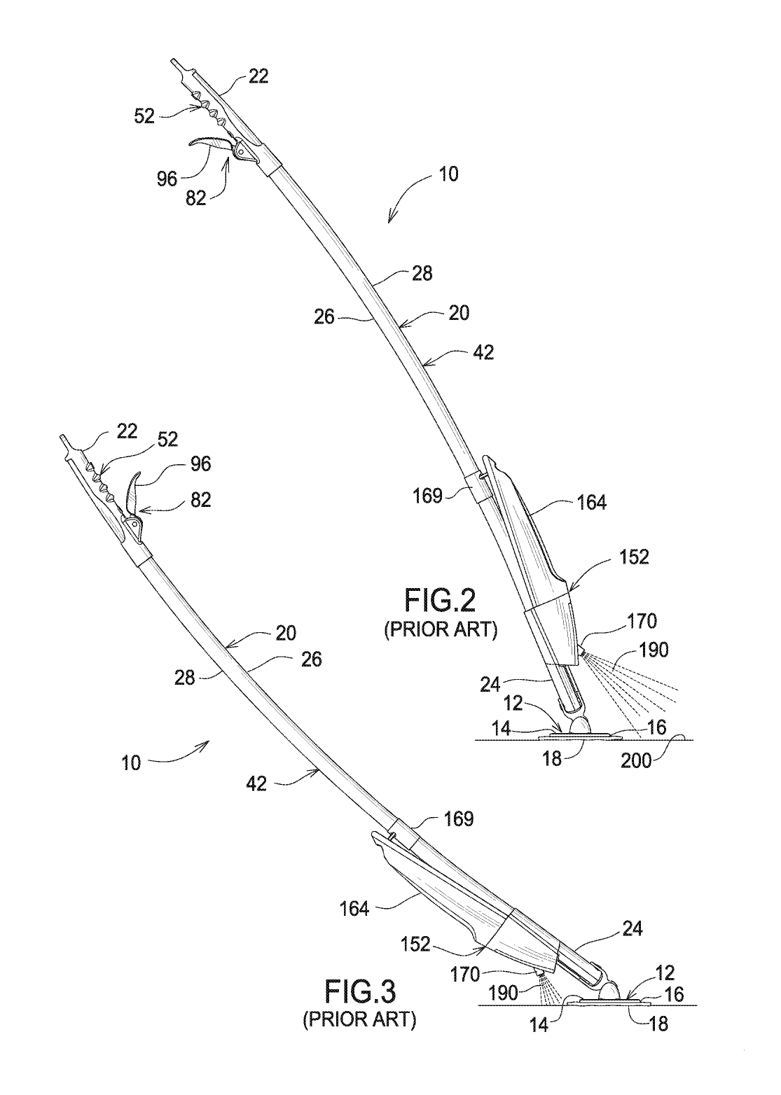

A bow shaped handle 20 is pivotally attached to the mop head 12. Bow shaped handle 20 has a distal end 22 positioned remotely from the mop head and a proximal end 24 positioned near the mop head 12. Bow shaped handle 20 may have a circular cross section and has a concave side 26, FIGS. 2 and 3, which is normally the trailing side of the mop, and has a convex side 28, which is normally the leading side of mop handle 20.

Bow shaped handle 20 includes a first, relatively longer, handle portion 42, which may be a tubular member with a cylindrical cavity 43 and which may be constructed from relatively high strength material such as aluminum, carbon fiber, high strength plastic or the like.

A prior art fluid dispense assembly 152, as best shown in FIG. 4, includes a fluid reservoir member 154, which is attached to the second handle portion 142 as by integral sleeve portion 156. A mechanical pump assembly 158 is mounted in the first end 144 of the second relatively shorter handle portion 142. The pump is in fluid communication with a reservoir (not shown) inside the reservoir member 154.

The mechanical pump assembly 158 includes a reciprocal pump member 160, which is biased in the upward position illustrated in FIG. 4. A retained spike 162 may be mounted at the top of the pump member 160 and is adapted to connect the pump member 160 to end 116 of elongate cam follower 106. The fluid dispenser assembly 152 also includes a fluid supply tank 164, which holds cleaning fluid or the like.

Fluid supply tank 164 may comprise a tank head portion 166 which is adapted to be received in a mouth portion 168 of the fluid reservoir member 154 thus enabling fluid from the fluid tank 164 to flow into the fluid reservoir member 154. A spray nozzle 170, FIG. 1, is mounted at a forward surface of the fluid reservoir member 154 and may be angled at about 45° to the floor when the second relatively shorter handle portion 142 is in a vertical upright position. A valve member (not shown) positioned in the mouth 168 enables fluid from tank 164 to flow into a reservoir (not shown) within the reservoir member 154. The spray nozzle 170 may be positioned about 13 cm above the floor when the second handle portion 142 is in a vertical position.

In operation of the fluid dispenser assembly 152, depressing the reciprocal pump member 160 causes fluid from the internal reservoir to be sprayed out the nozzle 170. The tip of nozzle 170 may be located about 5 cm forward of the longitudinal axis of the second handle portion 142. As best shown in FIGS. 2 and 3, the reservoir member 154 is positioned substantially entirely on the convex side 28 of the mop handle 20. Straight handled mops having a fluid dispenser assembly such as 152 are also known in the art, such as, for example, floor mops available from Bona USA of 2550 South Parker Road, Aurora, Colo. 80014. Accordingly, the structure of the fluid dispenser assembly 152 will not be further described herein.

FIG. 5 is a block diagram of a heating assembly 200 for heating floor cleaning liquid. The heating assembly 200, in some embodiments, is part of a mop assembly. For example, it may be incorporated into a mop assembly such as prior art mop assembly 10 that is illustrated in FIGS. 1-4. The assembly 200 includes a mop liquid container bottle 210, which in one example embodiment is used as a replacement for a prior art unheated container such as fluid supply bottle/tank 164 shown in FIGS. 1-4. The container bottle 210 includes a bottle body 212 and a bottle cap 214. A conduit 216 extends below the bottle cap 214. The conduit 216 may include a one-way valve enabling flow of cleaning liquid out of the bottle 212 when it is in an inverted position such as illustrated in FIG. 5. The cap 214 and the conduit 216 that extends below it are adapted to be received by a receptacle 218. The receptacle 218 in one embodiment is part of a wall mounted heating system. In another embodiment the receptacle 218 is mounted on the mop handle of an associated mop.

With continued reference to FIG. 5, a resistive heater 220 is positioned adjacent and sufficiently close to the bottle body 212 to transfer heat to the cleaning liquid in the bottle 210. The resistive heater may be connected to a power line 226 that is controlled by a thermostat assembly 224. The thermostat controls the flow of electricity to the resistive heater 220 to maintain it at the thermostat temperature setting. The power line 226 may be connected to a power source such as a wall socket 230 by a conventional electric plug 228. An analog to digital converter 232 may be connected to the power line 226 to convert the alternating current from the socket 230 to direct current, which is supplied through line 234 to a microcontroller 240. Another direct current line 142 from the microcontroller is connected to ground through a switch 144.

As further shown by FIG. 5, a first thermal sensor 250 is positioned to sense the temperature of the resistive heater 220 and is connected to a microprocessor 240 by line 252. A second thermal sensor 256 is positioned to sense the temperature of the floor cleaning liquid in the bottle body 212 and is connected to the microprocessor 240 by a line 258. An optical sensor 260 or other proximity sensor is located so as to sense the position of a mirror unit 264 mounted on the bottle body 212. Signal are sent from the optical sensor 260 to the microprocessor though line 268. The microprocessor processes these signals and takes various actions in response thereto. For example, based upon the temperature of the thermal sensors 250 and 256 the microcontroller controls the thermostat 224 to initially raise the temperature and then maintain the liquid in the bottle body 212 at a preset temperature. The selected temperature is below the boiling temperature of the cleaning liquid to avoid the production of steam. The microprocessor may send illumination signals to via lines 272, 276 to green and yellow LED units 274, 278, respectively, to indicate predetermined conditions of the cleaning fluid in bottle body 212. For example a yellow light may indicate that the system is still heating the water in bottle body 212 and the green light may indicate that the liquid has reached a desired temperature.

The signal from the optical sensor 260 is used by the microprocessor to determine when the bottle body 212 is properly seated in the receptacle 218. In some embodiments no electric power is provided to the heater 220 until the bottle body 212 is properly seated in the receptacle 218.

With continued reference to FIG. 5, in another embodiment, as illustrated in dashed lines, a battery charger/voltage regulator 236 and connected rechargeable battery unit 238 replaces the AID converter 232. In this alternative embodiment, power may be provided to the heater 220, as needed, even after the power cord 226 is disconnected from the power source 230. Thus, in this embodiment the associated floor mop may continue to dispense heated cleaning liquid for a longer time after the power cord is removed. However, it would also be possible to simply operate the associated mop assembly to clean a floor while the mop assembly is attached to a wall socket 230 by the power cord 226.

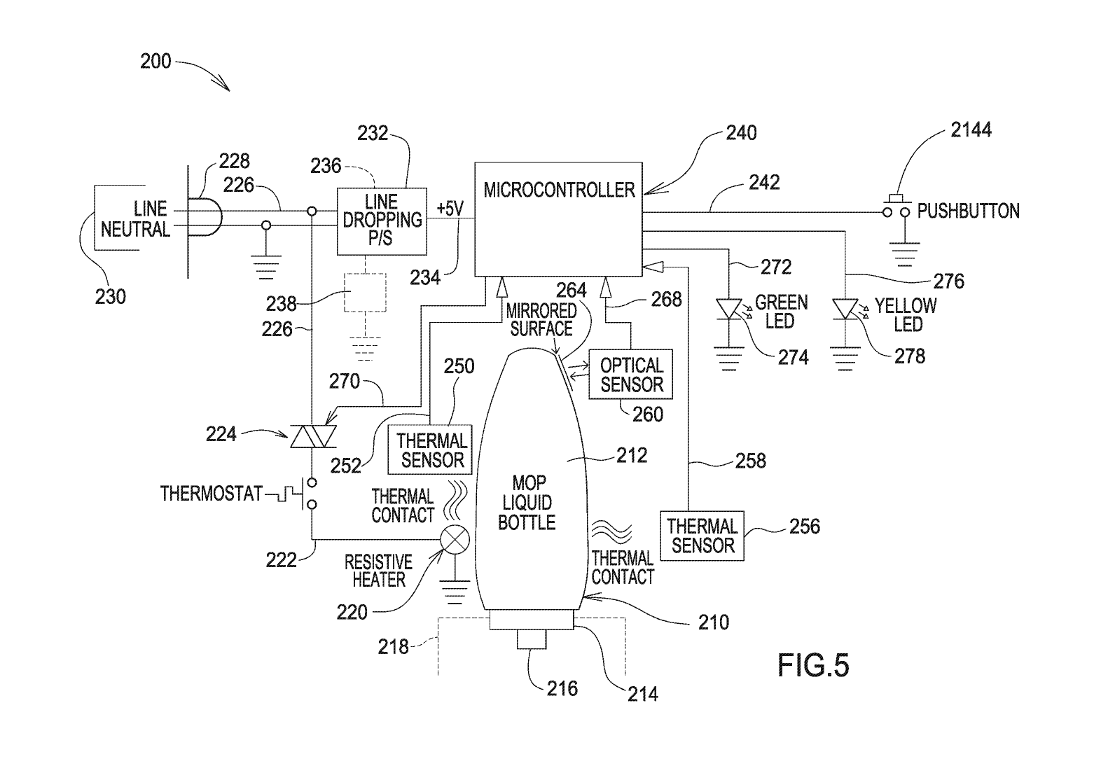

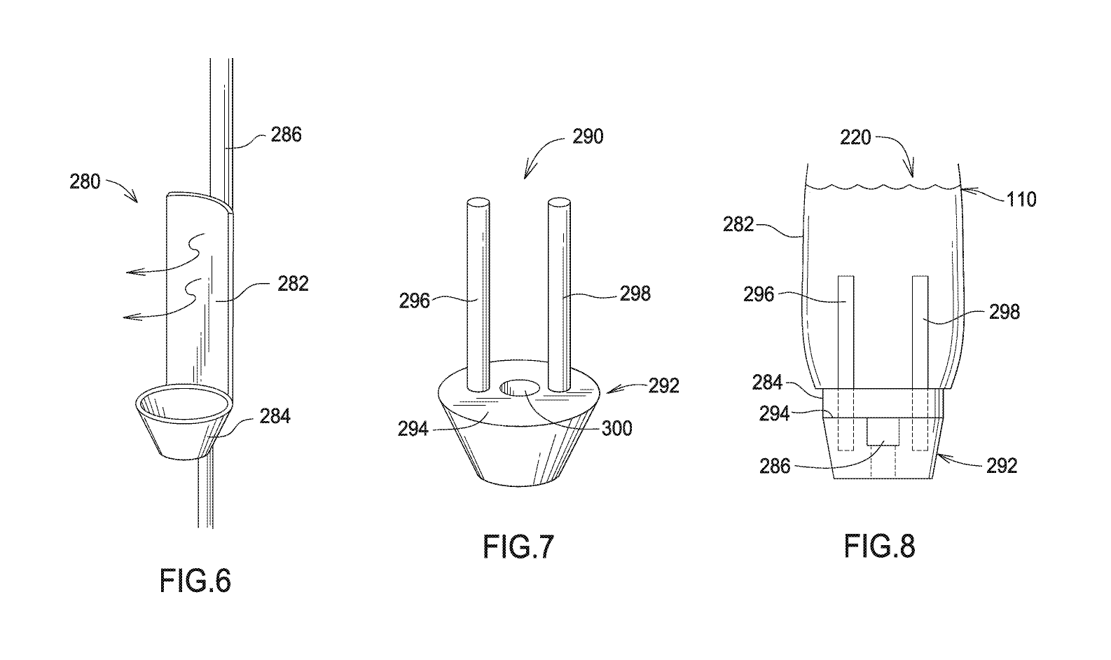

FIG. 6 illustrates a heating plate assembly 280. This assembly includes a heating plate 282 and a bottle valve adapter/socket 284 that are mounted on a mop handle 286. Heat from the heating plate 282 heats cleaning liquid in a bottle (not shown) received in the adapter 284. A heating control system such as described above in FIG. 5 may be used to control the assembly of FIG. 6.

FIG. 7 is an isometric drawing of a bottle insert shaft type heating assembly 290, and FIG. 8 is a side elevation view of the heating assembly 290 with a cleaning liquid container/bottle 282, such as described with reference to FIG. 5, mounted thereon. The system 290 includes a bottle docking unit 292 having a flat face 294, which interfaces with a bottle cap 284 that covers an open end of the bottle 282. First and second heating shafts 226, 228, which may each include an internal heating element such as a resistive coil, extend upwardly from the flat face 224. The bottle cap 284, in the embodiment of FIG. 8, has two holes therein adapted to sealingly receive the heating shafts 296, 298 therethrough. Thus, direct contact between the liquid in the bottle 291 and the heating shafts 296, 298, is provided by this system 290. A hole 300/female socket at the center of the docking unit flat face 294, extends through the docking unit 292 and is adapted to receive a conduit/valve assembly 286 extending from the bottle cap 284.

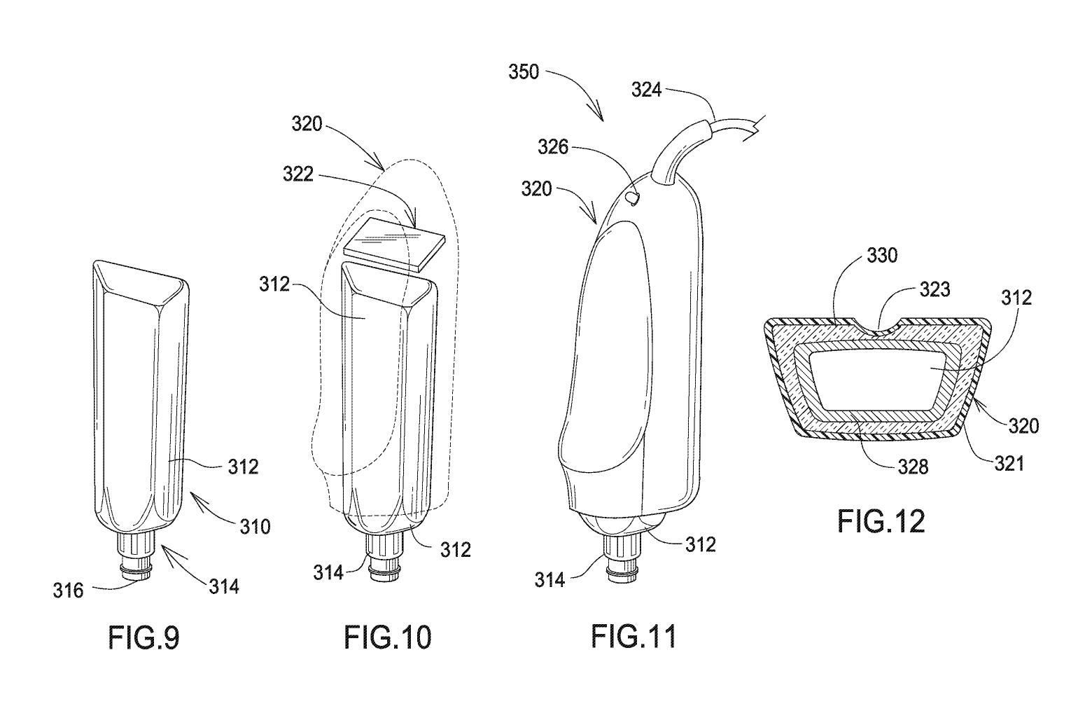

FIGS. 9 through 12 illustrate an example cleaning liquid heating and spray assembly 350. FIG. 9 is an isometric view of a floor liquid container bottle assembly 310. The assembly 310 includes a bottle 312. A removable cap and orifice assembly 314 covers an open end of the bottle 312 and has a displaceable stud member 316 extending therefrom.

FIG. 10 is a partially transparent view of the container bottle assembly 310 of FIG. 9 and certain control circuitry 322 that are both enclosed in an insulating and heating shroud 320. In one embodiment, the shroud 320 also encloses a heating unit, such as plate 212 (shown in FIG. 6) and control electronics, such as a printed circuit board mounted microprocessor 322.

As shown by FIG. 11, a power cord 324 may extend into the shroud 320 to provide energy for powering the system electronics 322 and also for heating the heating element 328, FIG. 12. As further shown by FIG. 11, an on-off switch 226 may extend out of the shroud 320, enabling the heating system to be conveniently switched off or on.

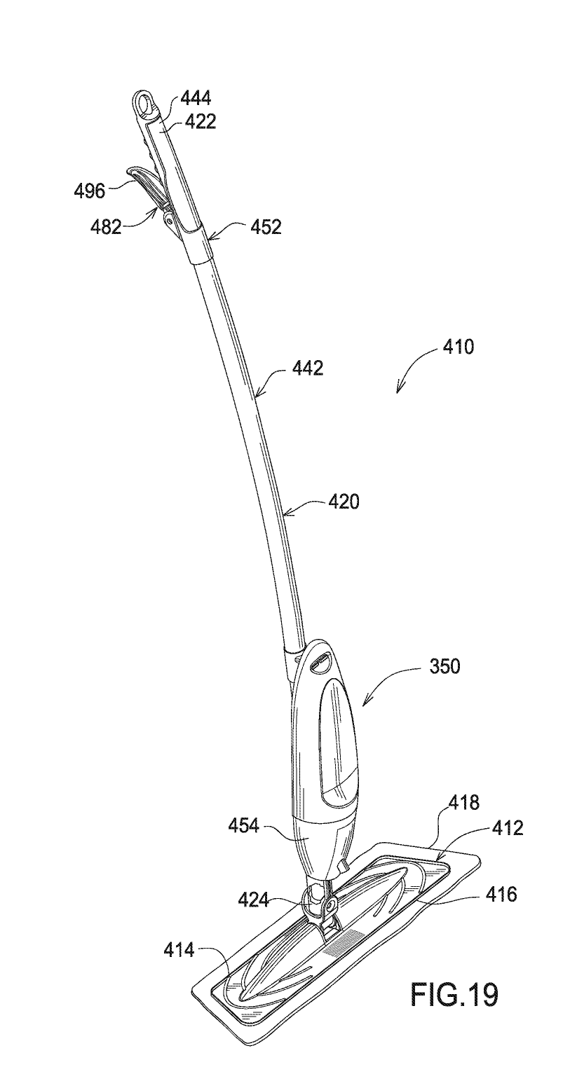

FIG. 12 is a cross sectional view of the assembly of FIGS. 10 and 11. As shown by FIG. 12, the bottle 312 may be encompassed by a flexible heating sleeve 328 that conforms to the shape of the bottle 312. The heating sleeve 328 may, for example, contain resistive coils therein similar to a conventional electric sleeping blanket. A layer of insulation 330 surrounds the heating sleeve 328 and a plastic housing 321 surrounds the insulation 330. Thus, the heating shroud 320 may comprise the heating sleeve 328, the insulation 330, and the plastic housing 321. Plastic housing 321 may have a half round indention 323 therein that is adapted to conform to a mop handle to facilitate mounting of the shroud 320 on the mop handle, e. g. 420, FIG. 19.

FIGS. 13 through 18 illustrate a second liquid heating and spray assembly 352. As shown by FIG. 13, a spray assembly 360 includes a reservoir housing 362 having a half round portion 364 adapted to facilitate attachment to a mop handle. A stud member 366 is positioned within the reservoir housing 362, and a spray nozzle 368 extends outwardly from the housing 362.

A liquid heating assembly 370 is mounted on a mop handle above the spray assembly 360. Liquid heating assembly 370 includes a flat plate portion 372 having a hole 374 therein and also includes a half round portion 376 adapted for mounting liquid heating assembly 370 on a mop handle. A peripheral rim portion 378 extends upwardly from the flat plate 372 and has a generally semicircular shape. A curvilinear peripheral wall 380 extends downwardly from the peripheral rim portion 378 below the flat plate portion 372. The curvilinear peripheral wall 380 and the flat plate 372 define a liquid heating chamber 381. A power cord socket 382 in the peripheral wall 380 enables attachment of the heating assembly 370 to a power source, such as a conventional wall socket. A printed circuit board 383, as best shown in FIG. 17, may be mounted on the flat plate 372. The printed circuit board 383 is operatively connected, as through an analog to digital converter, to the power socket 382.

An LED 385 in the peripheral wall 380 and connected to the printed circuit board 383, provides a display indicative of various system states, for example, a liquid fully heated state in which the liquid in the chamber 381 has been heated to a predetermined temperature. A sleeve 386 at the lower end of the liquid heating assembly 370 is adapted to seat in the reservoir housing of the spray assembly 360.

The outer wall 380 may be constructed from an insulating material which has a resistive heating coil 389 embedded therein. The heating coil is operatively connected to receive electricity from the power socket. This energy flow to the heating coil 389 from the electric socket 382 is controlled by a microprocessor on the printed circuit board 383.

A bottle assembly 390, as best shown in FIGS. 13 and 18, includes a liquid container/bottle with a recloseable end portion. A container cap 394 covers the open end and has an outlet conduit/valve member 396 extending therefrom. The conduit member 396 co-acts with stud member 366 of the spray assembly, which causes the valve to open and discharge heated cleaning liquid in the heating reservoir 381 into the reservoir housing 362 of the spray assembly 360.

FIG. 19 illustrates a floor mop 410 having a conventional mop head 412 with a trailing edge 414 and a leading edge 416. A cleaning pad 418 may be attached to the mop head 412 as by hook and loop type fasteners strips (not shown) mounted on the bottom of the mop head or by adhesives strips, tie-on cords or other cleaning pad attachment means. A handle 420, which in the example embodiment of FIG. 13 is bow shaped, is pivotally attached to the mop head 412. Handle 420 has a distal end 422 positioned remotely from the mop head and a proximal end 424 positioned near the mop head 412.

A cleaning liquid heating and spray assembly 350, as described above with reference to FIG. 13, is mounted on the handle 420, FIG. 19. In one example embodiment, the floor mop 420 may be the same as the prior art floor mop 10 of FIG. 1, except that the liquid heating and spray assembly 350 replaces the prior art fluid dispense assembly 152. An advantage of the floor mop assembly 410 illustrated in FIG. 1 is that it may be provided simply by removing the fluid dispense assembly 152 from a prior art mop 10, such as illustrated in FIG. 1, and replacing it with the liquid heating and spray assembly 350 shown in FIGS. 13 and 19. The electrical heating and control system for the heating and spray assembly 350 may be the same as that described above with reference to system 200 in FIG. 5. Thus, the heating and spray assembly 350 shown in FIG. 13 may constitute a replacement kit for changing the mop assembly of FIG. 1 to the heated mop assembly 410 of FIG. 19.

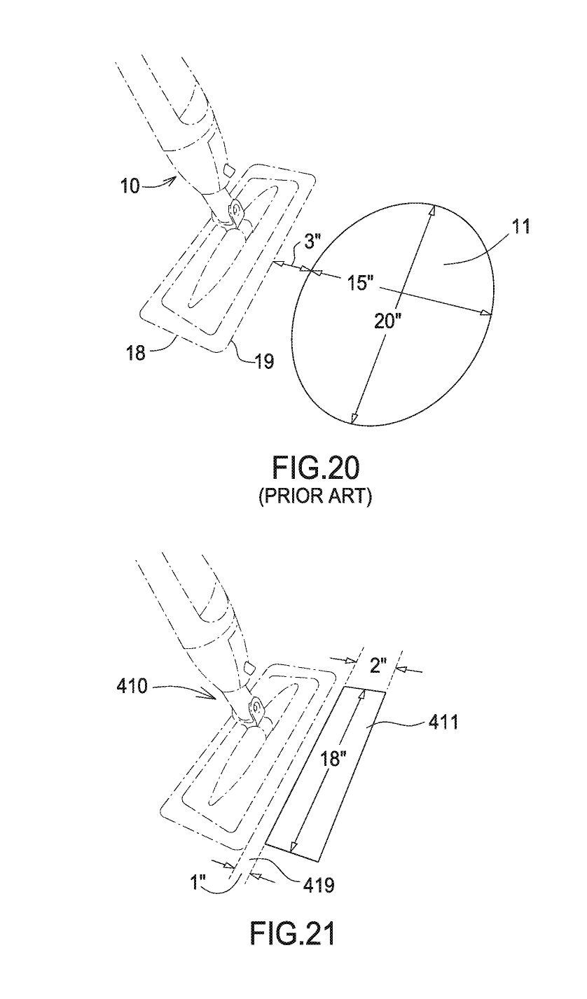

FIG. 20 illustrates the spray pattern 11 of a prior art floor mop, such as floor mop 10 described above with reference to FIG. 1. The spray pattern 11 is an ellipse having a major axis of 20 inches and a minor axis of 15 inches. The pattern is positioned 3 inches in front of the leading edge 19 of a cleaning pad 18 mounted on the floor mop 10. The inventors have noted that spraying cleaning liquid from the nozzle 170 has the effect of cooling the liquid in the spray assembly liquid reservoir 154. The inventors have also noted that the larger the area of the spray pattern and the greater the distance of the spray pattern from the leading edge 19 of the mop pad 18, the greater the total heat loss from the cleaning liquid in the liquid reservoir 154. In a liquid heating floor mop, such as floor mop 410 illustrated in FIG. 19, it is generally desirable to limit heat loss in the cleaning liquid in order to keep the cleaning liquid at an elevated temperature through the entire floor cleaning operation.

In the floor mop 411 described with reference to FIG. 19, the spray pattern 411, FIG. 21, is smaller and closer to the mop pad leading edge 419 than with the floor mop 10. In one embodiment the spray pattern 411 of mop 410 has a generally rectangular shape extending 18 inches laterally and 2 inches in the direction of mop travel. This pattern 411 is located 1 inch in front of the leading edge 419. By reducing the size of the spray pattern and the distance that the spray must travel, less liquid is discharged with each spray, and thus less cooling of the liquid in the liquid reservoir 454 takes place. The size of floor that may be cleaned without reheating the cleaning liquid is thus increased.

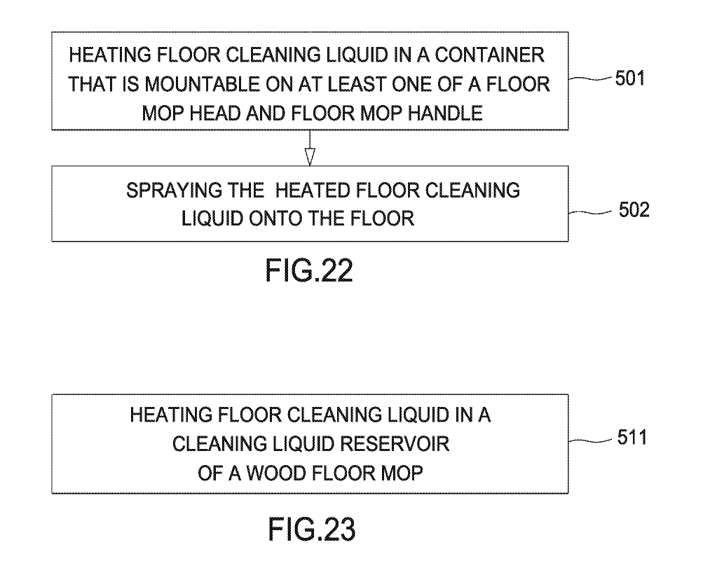

FIG. 22 is a block diagram of an example embodiment of a method of cleaning a floor with a floor mop. The method includes, as illustrated at block 501, heating floor cleaning liquid in a container that is mountable on at least one of a floor mop head and floor mop handle. The method also includes, as illustrated at block 502, spraying the heated floor cleaning liquid onto the floor.

FIG. 23 is a block diagram of an example embodiment of a method of cleaning a wood floor that includes, as shown at block 511, heating floor cleaning liquid in a cleaning liquid reservoir of a wood floor mop.

Although various embodiments of a wood floor mop assembly with an associated cleaning liquid heater have been expressly described in detail herein, it will be obvious to those skilled in the art, after reading this disclosure, that the wood floor mop assembly may be alternatively embodied. It is intended that the appended claims be broadly construed to cover such alternative embodiments, except as limited by the prior art.

What is claimed is:

1. A wood floor mop assembly comprising:
a liquid reservoir adapted to hold floor cleaning liquid;
a liquid spray nozzle assembly in selective fluid communication with floor cleaning liquid in the liquid reservoir;
a heating unit operatively associated with the liquid reservoir and adapted to heat floor cleaning liquid in the liquid reservoir.

2. The floor mop assembly of claim 1 wherein the heating unit is adapted to heat floor cleaning liquid in the liquid reservoir to a temperature less than the boiling temperature of the floor cleaning liquid.

3. The floor mop assembly of claim 1 further comprising:
a mop handle having a first end and a second end; and
a mop head mounted at the first end of the mop handle;
wherein the liquid reservoir and heating unit are attached to at least one of the mop handle and the mop head.

4. The floor mop of claim 3 wherein the liquid reservoir and the heating unit are mounted on the mop handle.

5. The floor mop assembly of claim 1 wherein the heating unit comprises an electrical cord adapter enabling the heating unit to be electrically connected to a wall outlet.

6. The floor mop assembly of claim 1 wherein the heating unit comprises a mobile power source.

7. The floor mop assembly of claim 6 wherein the mobile power source comprises a battery.

8. The floor mop assembly of claim 1 wherein the heating unit comprises at least one heatable structure.

9. The floor mop of claim 8 wherein the at least one heatable structure comprises a heating plate.

10. The floor mop assembly of claim 8 wherein the liquid reservoir comprises a liquid container having at least one opening therein adapted to receive the at least one heatable structure.

11. The floor mop assembly of claim 10 further comprising a locking assembly operable to lock the liquid container to the mop assembly in response to at least one detection signal.

12. The floor mop assembly of claim 11 wherein said at least one detection signal comprises a proximity signal indicating that said liquid container is in a predetermined seated position on said mop assembly.

13. The floor mop assembly of claim 11 wherein said at least one detection signal comprises a heating detection signal indicating that heating energy is being supplied by said heatable shaft.

14. The floor mop assembly of claim 11 wherein said at least one detection signal comprises a temperature detection signal indicating the temperature of the cleaning fluid in the liquid container.

15. A heating assembly for heating cleaning liquid comprising:
a container support unit for supporting a liquid container therein;
a heater positioned proximate the container support unit for heating liquid in a container supported by the container support unit;
a heater thermal sensor for sensing the temperature of the heater;
a liquid thermal sensor for sensing the temperature of cleaning liquid in a liquid container supported by the container support unit.

16. The heating assembly of claim 15 further comprising a proximity sensor for sensing the proximity of a liquid container supported by the container support unit.

17. The heating assembly of claim 16 further comprising controller circuitry for receiving a signal from the heater thermal sensor and the liquid thermal sensor and for generating a signal in response thereto for controlling the heater to maintain the liquid in the container at a predetermined temperature.

18. The heating assembly of claim 17 further comprising a locking assembly operably associated with said container support unit for locking a container to said support unit, said controller circuitry receiving said proximity sensor signal and sending a locking signal to lock said locking assembly in response to sensing a container at a predetermined position in said container support unit by said proximity sensor.

19. The heating assembly of claim 17 further comprising an insulating shroud positionable over a container in said container support unit wherein said thermal sensors and said proximity sensor and said controller circuitry are positioned inside said shroud.

20. A kit for retrofitting a mop having a mop handle, a liquid reservoir and a liquid reservoir support mounted on the mop handle, the kit comprising:
a replacement liquid reservoir adapted to be operatively received in the reservoir support;
a heating unit supported proximate said reservoir support; and
a power unit connectable to said heating unit.
